(19) United States
(12) Patent Application Publication
(10) Pub. No.: US 2018/0056856 A1
(43) Pub. Date: Mar. 1, 2018

(54) Method of Indicating Vehicle Deceleration Rates

(71) Applicant: Gerda Shupe, Yountville, CA (US)

(72) Inventor: Gerda Shupe, Yountville, CA (US)

(21) Appl. No.: 15/252,958

(22) Filed: Aug. 31, 2016

(51) Int. Cl. B60Q 1/44

(52) U.S. Cl. CPC B60Q 1/444; B60Q 1/46

(57) ABSTRACT

A method of indicating vehicle deceleration rates is used to help drivers discern how fast a vehicle is decelerating. The method of the present invention is performed by a system that includes a vehicle with a braking system. The braking system includes a pedal sensor and a braking control unit. The pedal sensor is used to measure the force applied to the brake pedal of the vehicle, while the braking control unit is used to categorize the measurements taken by the pedal sensor. The system also includes an indicator light system for the vehicle system. A plurality of braking tiers is managed by the braking control unit and is used to activate the indicator light system to varying extents. The braking control unit compares the brake application force with each of the braking tiers to determine how the indicator light system is activated.

### FIELD OF THE INVENTION

The present invention relates generally to methods of indicating the deceleration of a vehicle. More specifically, the present invention relates to methods of indicating various rates of deceleration so that drivers may be able to easily distinguish how rapidly a vehicle is decelerating.

### BACKGROUND OF THE INVENTION

Brake lights are required on all road vehicles in order to be deemed legal to drive. This is because brake lights help to alert drivers in the event that a vehicle is decelerating. Though it is possible to determine that a vehicle is decelerating without seeing the brake lights, the inclusion of brake lights helps to improve reaction times and alert distracted drivers. Though common brake lights are useful for alerting drivers that a vehicle is decelerating, it can be difficult to discern the rate at which the vehicle is decelerating. This can be due to a number of factors, including weather conditions, distance between the driver and the decelerating vehicle, and many other variables. Without knowing how rapidly the vehicle is decelerating, the driver can easily overcompensate by unnecessarily slamming the brakes of their vehicle or undercompensate by not braking hard enough. Both reactions can lead to a potentially hazardous situation for any drivers in the immediate area.

Accordingly, there is a present need for a means of indicating the rate at which a vehicle is decelerating. The present invention uses a pedal sensor incorporated into a vehicle to measure the force applied to the brakes of the vehicle. The force applied to the brakes is used to categorize the rate which the vehicle is decelerating. Based on the vehicle's deceleration rate, the brake lights may be illuminated at varying intensities, at least one additional light may be illuminated, or the hazard lights of the vehicle may be illuminated.

### BRIEF DESCRIPTION OF THE DRAWINGS

FIG. 1 is a system diagram of the present invention.

FIG. 2 is a flowchart describing the general process of the present invention.

FIG. 3 is a flowchart describing the steps of executing a corresponding light pattern for a low tier.

FIG. 4 is a flowchart describing the steps of executing a corresponding light pattern for a moderate tier.

FIG. 5 is a flowchart describing the steps of executing a corresponding light pattern for a high tier.

FIG. 6 is a flowchart describing the steps of disabling hazard lights with a hazard button.

FIG. 7 is a flowchart describing the steps of flashing the hazard lights for a predetermined period of time.

FIG. 8 is a flowchart describing the steps of executing the corresponding light pattern for the low tier by illuminating the indicator light system at a first intensity.

FIG. 9 is a flowchart describing the steps of executing the corresponding light pattern for the moderate tier by illuminating the indicator light system at a second intensity.

FIG. 10 is a flowchart describing the steps of executing the corresponding light pattern for the high tier by illuminating the indicator light system at a third intensity.

### DETAILED DESCRIPTION OF THE INVENTION

All illustrations of the drawings are for the purpose of describing selected versions of the present invention and are not intended to limit the scope of the present invention.

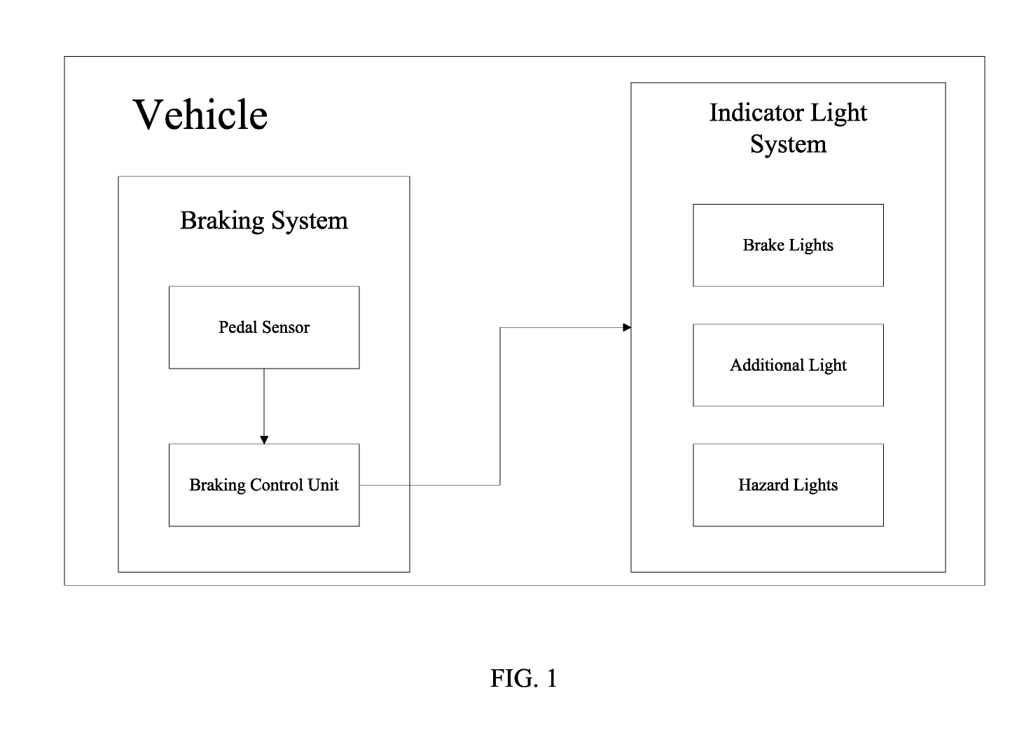

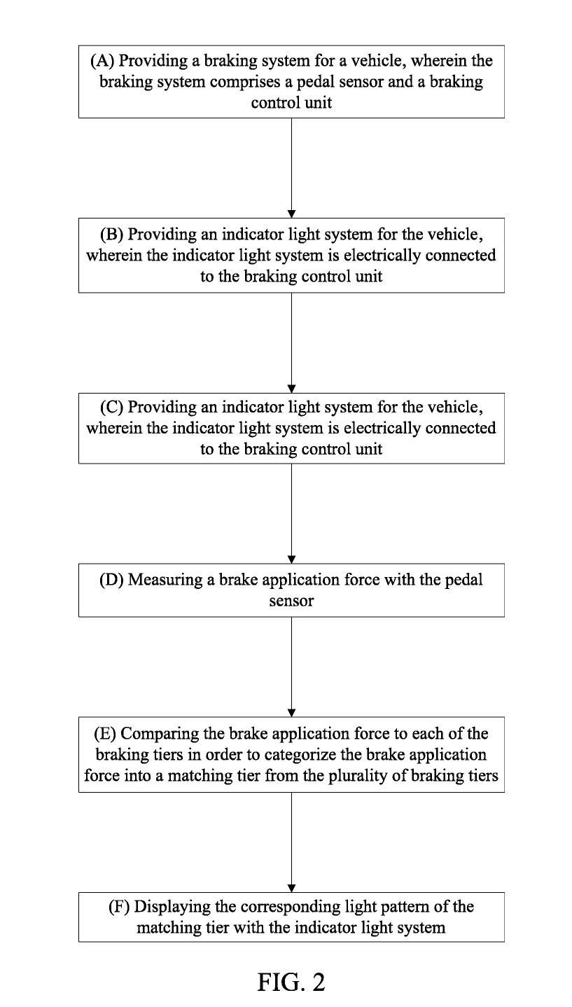

With reference to FIGS. 1-2, the present invention is a method of indicating vehicle deceleration rates. The present invention is used to alert drivers to the rate of deceleration for a vehicle. The method of the present invention is performed by a system that comprises a braking system for a vehicle, wherein the braking system comprises a pedal sensor and a braking control unit (Step A). The pedal sensor is integrated into the brake pedal of the vehicle and is used to measure the extent in with the brake pedal is depressed. The braking control unit is used to analyze information from the pedal sensor and respond accordingly. The system further comprises an indicator light system for the vehicle, wherein the indicator light system is electrically connected to the braking control unit (Step B). The indicator light system is used to alert drivers around the vehicle if the vehicle is decelerating. The system further comprises a plurality of braking tiers managed by the braking control unit, wherein each of the braking tiers is associated with a corresponding light pattern (Step C). The plurality of braking tiers is used to rank measurements received from the pedal sensor. When using the present invention, the pedal sensor measures a braking application force (Step D). The braking application force is tied to how fast the vehicle decelerates. The braking control unit compares the brake application force to each of the braking tiers in order to categorize the brake application force into a matching tier from the plurality of braking tiers (Step E). Once the brake application force has been categorized, the indicator light system displays the corresponding light pattern of the matching tier (Step F). The corresponding light pattern is meant to visually represent the extent to which the vehicle is decelerating.

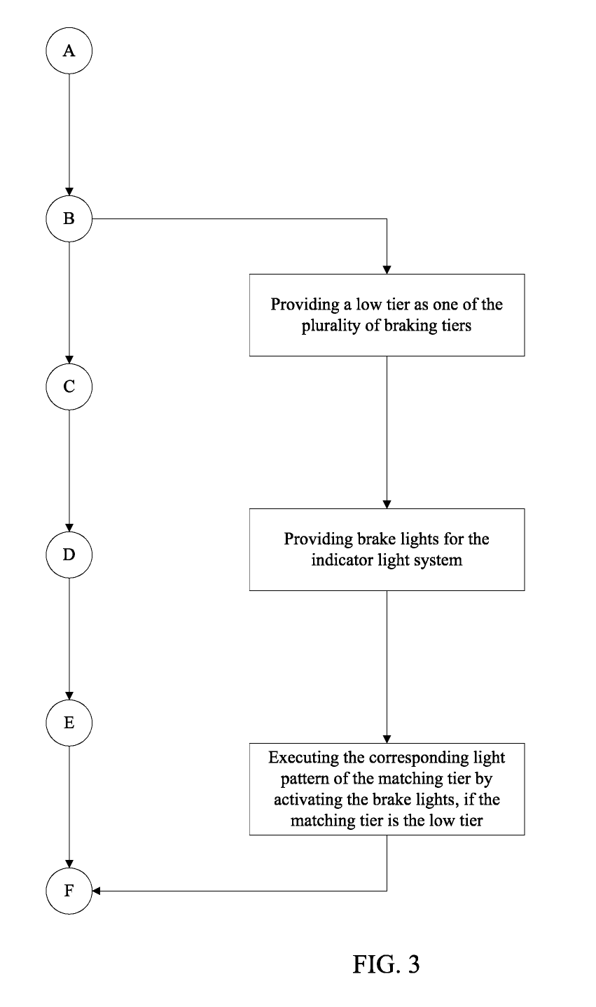

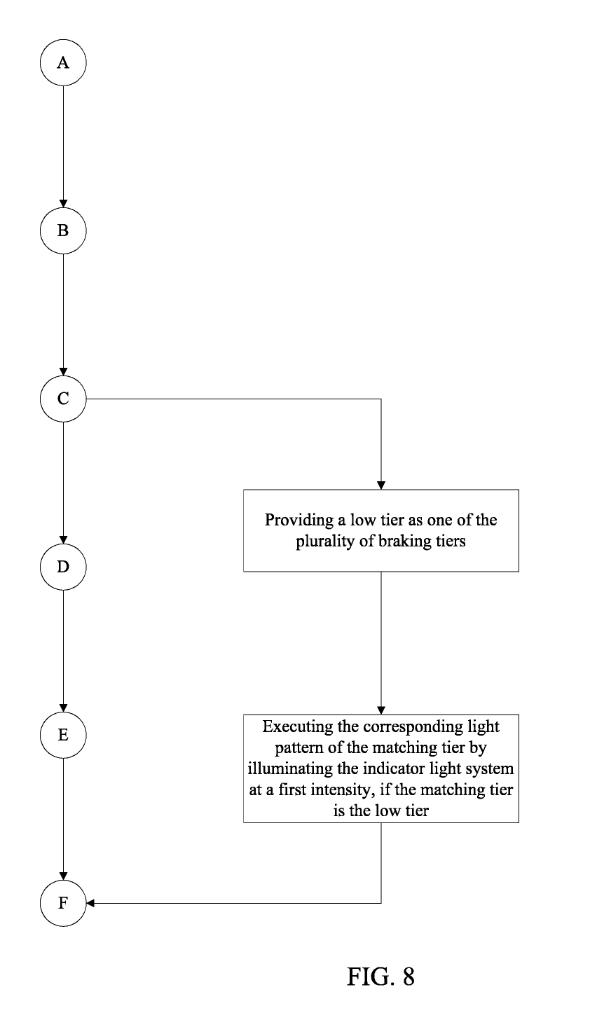

In reference to FIG. 3 and FIG. 8 a low tier is provided as one of the plurality of braking tiers and is used to categorize low brake application forces. The indicator light system comprises brake lights which are used to signify deceleration. In the preferred embodiment of the present invention, the brake lights are used exclusively when indicating low rates of deceleration. The brake lights of the present invention are designed to meet industry standards for the vehicle. In the preferred embodiment of the present invention, if the matching tier is the low tier, the corresponding light pattern of the matching tier is executed by activating the brake lights. If the braking application force is increased such that the matching tier is higher than the low tier, additional actions are taken. Conversely, if the brake application force is removed, the brake lights are turned off. In an alternative embodiment of the present invention, indicating deceleration rates may involve illuminating the indicator light systems at various intensities. If, for example, the matching tier is the low tier, the corresponding light pattern of the matching tier is executed by illuminating the indicator light system at a first intensity. In this embodiment, the first intensity would likely be the lowest intensity. Additional intensities would be provided for increased rates of deceleration.

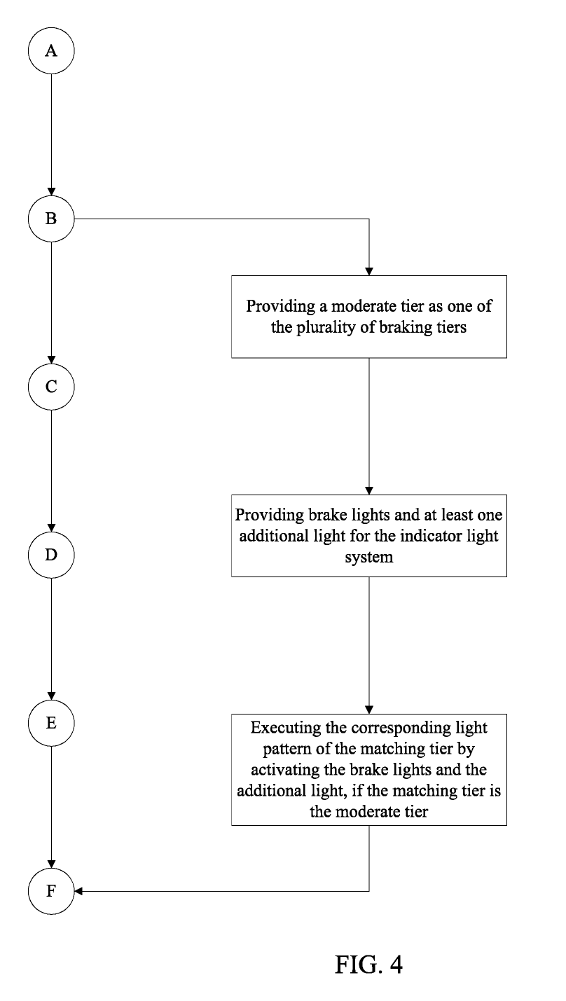

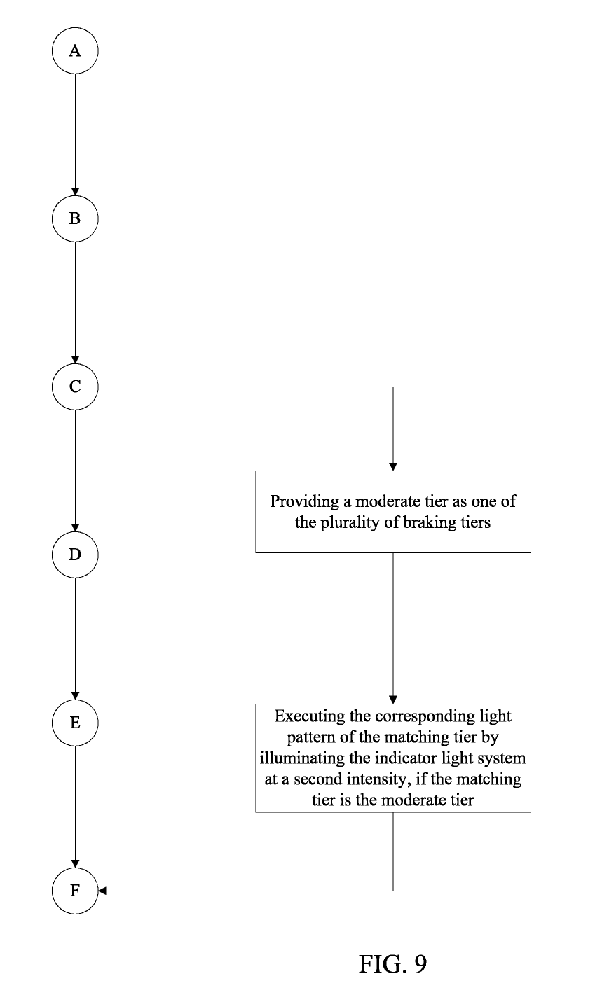

In reference to FIG. 4 and FIG. 9, a moderate tier is also provided as one of the plurality of braking tiers and is used to categorize moderate brake application forces. In addition to the brake lights, the indicator light system comprises at least one additional light. The at least one additional light is used to distinguish moderate rates of deceleration from low rates of deceleration. If the matching tier is the moderate tier, the corresponding light pattern of the matching tier is executed by activating the brake lights and the additional light. In the alternative embodiment of the present invention, if the matching tier is the moderate tier, the corresponding light pattern of the matching tier is executed by illuminating the indicator light system at a second intensity. The second intensity is used to help drivers distinguish between the low rates of deceleration and moderate rates of deceleration. In this embodiment, it is preferred that the second intensity is brighter than the first intensity.

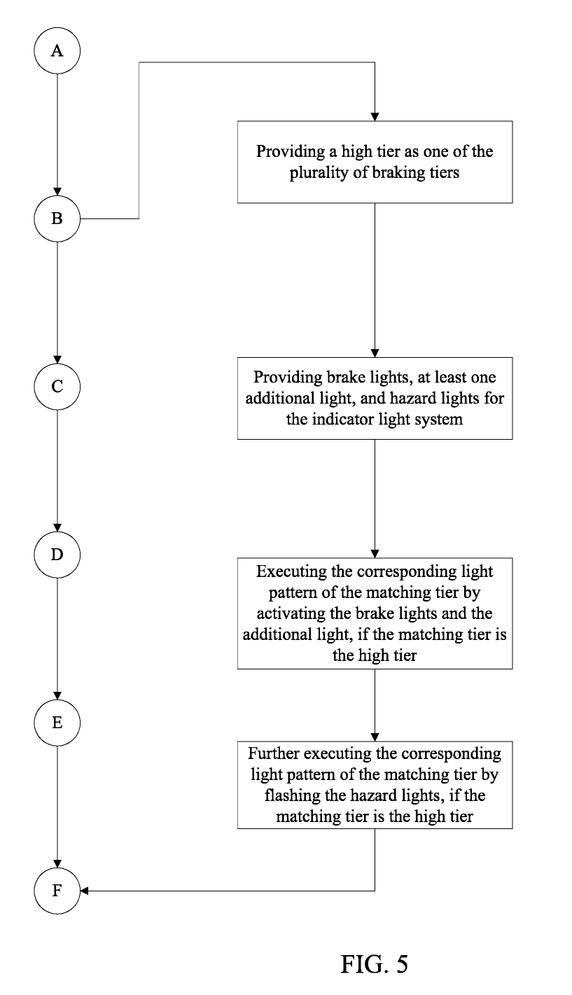

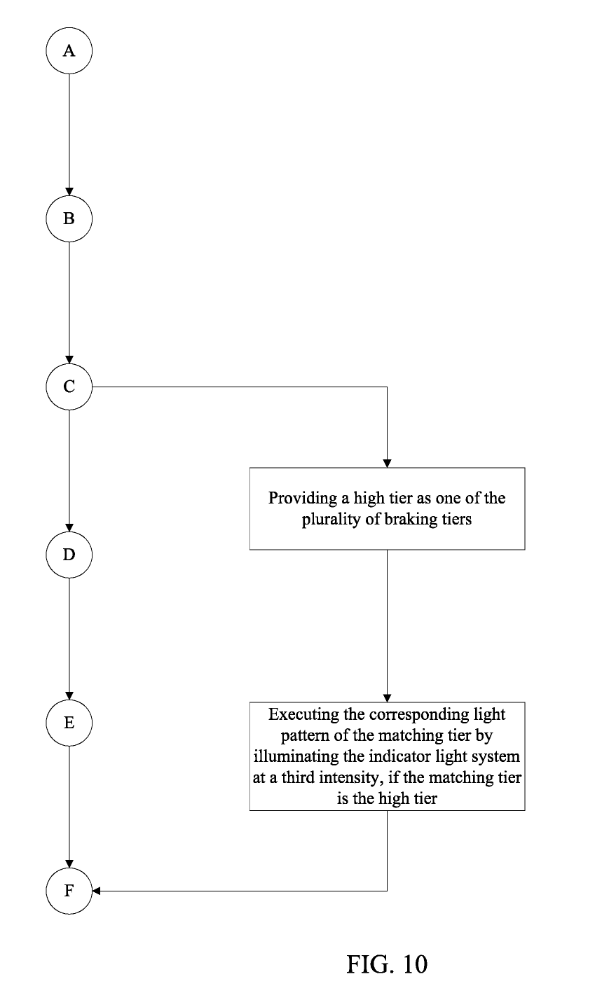

In reference to FIG. 5 and FIG. 10, a high tier is provided as one of the plurality of braking tiers. The high tier is used to categorize high brake application forces. In addition to the brake lights and the additional light, the indicator light system further comprises hazard lights. The hazard lights are used to distinguish high rates of deceleration from moderate and low rates of deceleration. If the matching tier is the high tier, the corresponding light pattern of the matching tier is executed by activating the brake lights and the additional lights and by flashing the hazard lights. In the alternative embodiment of the present invention, if the matching tier is the high tier, the corresponding light pattern of the matching tier is executed by illuminating the indicator light system at a third intensity. In this embodiment, the third intensity is the brightest, while the first intensity is the dimmest. This arrangement helps to make rapid rates of deceleration more easily distinguishable.

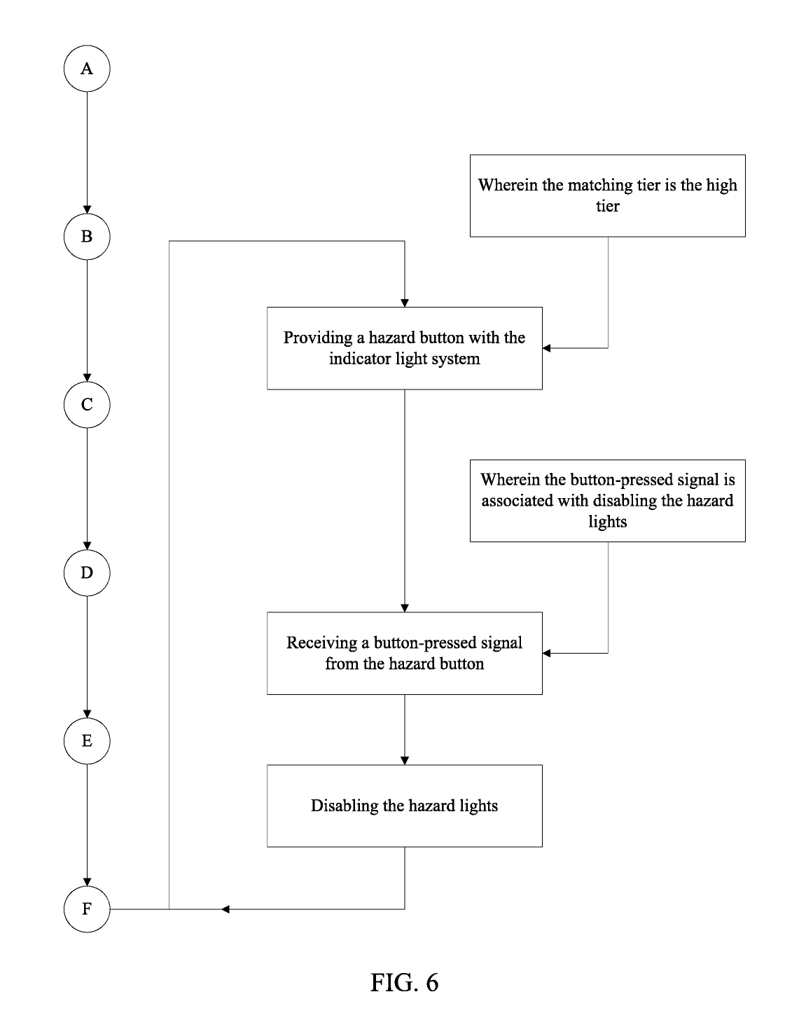

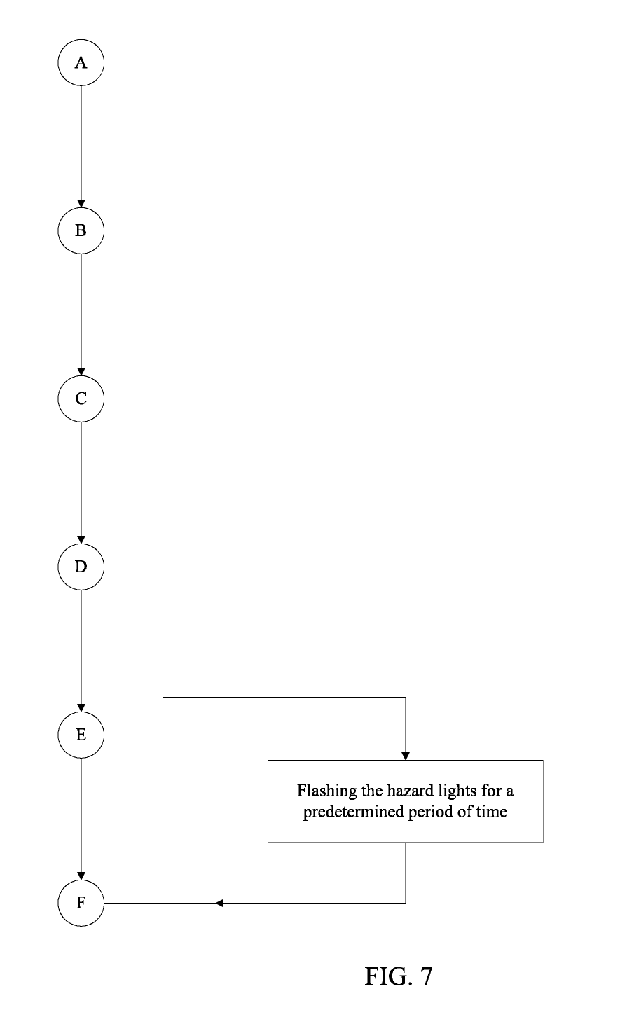

In reference to FIGS. 6-7, in the preferred embodiment of the present invention, the indicator light system comprises a hazard button. Like common vehicles, the hazard button is used to toggle the hazard lights of the vehicle. As previously mentioned, in the event that the matching tier is the high tier, the hazard lights are automatically activated. When the user presses the hazard button, a button-pressed signal is received from the hazard button. The button-pressed signal is associated with disabling the hazard lights, but in other situations may be used to activate the hazard lights. If the matching tier is the high tier, upon receiving the button-pressed signal, the hazard lights are disabled. This configuration helps to alert other drivers of rapid deceleration until the driver of the vehicle is able to safely deactivate the hazard lights. In an alternative embodiment of the present invention, the hazard lights are flashed for a predetermined period of time. After which point, the hazard lights are disabled. This embodiment has a similar effect but does not require user interaction to disable the hazard lights.

Although the invention has been explained in relation to its preferred embodiment, it is to be understood that many other possible modifications and variations can be made without departing from the spirit and scope of the invention as hereinafter claimed.

What is claimed is:

1. A method of indicating vehicle deceleration rates, the method comprises the steps of:
(A) providing a braking system for a vehicle, wherein the braking system comprises a pedal sensor and a braking control unit;
(B) providing an indicator light system for the vehicle, wherein the indicator light system is electrically connected to the braking control unit;
(C) providing a plurality of braking tiers managed by the braking control unit, wherein each of the braking tiers is associated with a corresponding light pattern;
(D) measuring a brake application force with the pedal sensor;
(E) comparing the brake application force to each of the braking tiers in order to categorize the brake application force into a matching tier from the plurality of braking tiers; and
(F) displaying the corresponding light pattern of the matching tier with the indicator light system.

2. The method of indicating vehicle deceleration rates as claimed in claim 1 comprises:
providing a low tier as one of the plurality of braking tiers;
providing brake lights for the indicator light system; and
executing the corresponding light pattern of the matching tier by activating the brake lights,
if the matching tier is the low tier.

3. The method of indicating vehicle deceleration rates as claimed in claim 1 comprises:
providing a moderate tier as one of the plurality of braking tiers;
providing brake lights and at least one additional light for the indicator light system; and
executing the corresponding light pattern of the matching tier by activating the brake lights and the additional light,
if the matching tier is the moderate tier.

4. The method of indicating vehicle deceleration rates as claimed in claim 1 comprises:
providing a high tier as one of the plurality of braking tiers;
providing brake lights, at least one additional light, and hazard lights for the indicator light system;
executing the corresponding light pattern of the matching tier by activating the brake lights and the additional light,
if the matching tier is the high tier; and
further executing the corresponding light pattern of the matching tier by flashing the hazard lights,
if the matching tier is the high tier.

5. The method of indicating vehicle deceleration rates as claimed in claim 4 comprises:
wherein the matching tier is the high tier;
providing a hazard button with the indicator light system;
receiving a button-pressed signal from the hazard button, wherein the button-pressed signal is associated with disabling the hazard lights; and
disabling the hazard lights.

6. The method of indicating vehicle deceleration rates as claimed in claim 4 comprises:
flashing the hazard lights for a predetermined period of time.

7. The method of indicating vehicle deceleration rates as claimed in claim 1 comprises:
providing a low tier as one of the plurality of braking tiers; and
executing the corresponding light pattern of the matching tier by illuminating the indicator light system at a first intensity,
if the matching tier is the low tier.

8. The method of indicating vehicle deceleration rates as claimed in claim 1 comprises:
providing a moderate tier as one of the plurality of braking tiers; and
executing the corresponding light pattern of the matching tier by illuminating the indicator light system at a second intensity,
if the matching tier is the moderate tier.

9. The method of indicating vehicle deceleration rates as claimed in claim 1 comprises:
providing a high tier as one of the plurality of braking tiers; and
executing the corresponding light pattern of the matching tier by illuminating the indicator light system at a third intensity,
if the matching tier is the high tier.
